(19) United States
(12) Patent Application Publication
(10) Pub. No.: US 2022/0150956 A1
(43) Pub. Date: May 12, 2022

(54) METHOD AND APPARATUS FOR RESOURCE DETERMINATION

(71) Applicant: Samsung Electronics Co., Ltd., Suwon-si, Gyeonggi-do (KR)

(72) Inventors: Qi XIONG, Beijing (CN); Feifei SUN, Beijing (CN); Bin YU, Beijing (CN); Chen QIAN, Beijing (CN)

(21) Appl. No.: 17/593,944

(22) PCT Filed: Mar. 27, 2020
(86) PCT No.: PCT/KR2020/004213

§ 371 Date: Sep. 28, 2021

(30) Foreign Application Priority Data
Mar. 28, 2019 (CN) 201910245735.3
Nov. 7, 2019 (CN) 201911105006.4

(51) Int. Cl. H04W 74/00; H04L 5/00

(52) U.S. Cl. CPC H04W 74/004; H04L 5/0023; H04L 5/0051

(57) ABSTRACT

A resource determination method and device are provided, wherein the resource determination method includes: obtaining resource configuration information of an uplink signal; based on the resource configuration information, obtaining first mapping information between a downlink beam and random access channel (RACH) resource, and second mapping information between the downlink beam and physical uplink shared channel (PUSCH) resource; according to the first mapping information and the second mapping information, obtaining the RACH resource mapped with the determined downlink beam and the PUSCH resource mapped with the determined downlink beam, and determining third mapping information between the RACH resource and the PUSCH resource; and according to the third mapping information and the determined RACH resource, determining available PUSCH resource.

### CROSS-REFERENCE TO RELATED APPLICATIONS

This application is a 371 of International Application No. PCT/KR2020/004213, filed Mar. 27, 2020, which claims priority to Chinese Patent Application No. 201910245735.3, filed Mar. 28, 2019, and Chinese Patent Application No. 201911105006.4, filed November 7, 2019, the disclosures of which are herein incorporated by reference in their entirety.

### BACKGROUND

### 1. Field

The present disclosure relates to a radio communication technical field, more particularly, to a resource determination method and apparatus in a wireless communication system.

### 2. Description of Related Art

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 GHz bands, so as to accomplish higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

As described above, various services can be provided according to the development of a wireless communication system, and thus a method for easily providing such services is required.

### SUMMARY

A method for resource determination is provided. The method comprises obtaining resource configuration information of an uplink signal; based on the resource configuration information, obtaining first mapping information between a downlink beam and a random access channel (RACH) resource, and second mapping information between a downlink beam and physical uplink shared channel (PUSCH) resource; according to the first mapping information and the second mapping information, obtaining RACH resource mapped with the determined downlink beam and PUSCH resource mapped with the determined downlink beam, and determining third mapping information between the RACH resource and the PUSCH resource; and according to the third mapping information and the determined RACH resource, determining available PUSCH resource.

### BRIEF DESCRIPTION OF THE DRAWINGS

Those skilled in the art will obtain a comprehensive understanding of the present disclosure through the following detailed description of exemplary embodiments of the present disclosure in conjunction with the drawings, in which:

FIG. 1 is a diagram illustrating a competition-based random access process in LTE-A according to embodiments of the present disclosure;

FIG. 2 is a flow diagram illustrating a resource determination method according to embodiments of the present disclosure;

FIG. 3 is a mapping diagram of SSB to PUSCH resource according to embodiments of the present disclosure;

FIG. 4 is a diagram of valid PUSCH resource according to embodiments of the present disclosure;

FIG. 5 is a mapping diagram between the RACH resource mapped with the same downlink beam and the PUSCH resource mapped with the same downlink beam according to embodiments of the present disclosure;

FIG. 6 is a mapping diagram between the RACH resource mapped with the same downlink beam and the PUSCH resource mapped with the same downlink beam according to embodiments of the present disclosure;

FIG. 7 is a diagram of mapping a plurality of preambles to one PUSCH resource unit according to embodiments of the present disclosure;

FIG. 8 is a diagram of mapping one preamble to a plurality of PUSCH resource units according to embodiments of the present disclosure;

FIG. 9 is a diagram illustrating determining available PUSCH resource through an interval value according to embodiments of the present disclosure;

FIG. 10 is a block diagram illustrating a resource determination device according to embodiments of the present disclosure;

FIG. 11 illustrates a resource determination device according to embodiments of the present disclosure; and

FIG. 12 illustrates a user equipment (UE) according to embodiments of the present disclosure.

### DETAILED DESCRIPTION

Embodiments of the present disclosure provide methods and apparatuses for resource determination are provided.

In one embodiment, an electronic apparatus for resource determination is provided. The electronic apparatus may include a transceiver and at least one processor operably connected to the transceiver. The at least one processor may be configured to obtain the resource configuration information of the uplink signal, based on the resource configuration information, obtain first mapping information between a downlink beam and a random access channel (RACH) resource, and second mapping information between a downlink beam and a physical uplink shared channel (PUSCH) resource, according to the first mapping information and the second mapping information, obtain the RACH resource mapped with the determined downlink beam and the PUSCH resource mapped with the determined downlink beam, and determine third mapping information between the RACH resource and the PUSCH resource, and determine available PUSCH resource according to the third mapping information and the determined RACH resource.

In one embodiment, the resource configuration information may include the resource configuration information from at least one of: a random access feedback of a random access process, downlink control information of scheduled uplink transmission, a radio resource control (RRC) configuration message, pre-configured parameter information, or a system message sent by a network side or other higher level control signaling.

In one embodiment, the resource configuration information comprises at least one of: four-step random access configuration information, two-step random access configuration information, downlink beam configuration information, or PUSCH resource configuration information.

In one embodiment, the at least one processor may further be configured to: determine a mapping relationship between the downlink beam and PUSCH time-frequency resource, determine a mapping relationship between the downlink beam and a demodulation reference signal (DMRS) port, determine a mapping cycle from the downlink beam to the PUSCH resource, determine a mapping period from the downlink beam to the PUSCH resource, and determine a mapping pattern period from the downlink beam to the PUSCH resource.

In one embodiment, the mapping relationship between the downlink beam and PUSCH time-frequency resource may include indexes of all downlink beams configured within one downlink beam period to PUSCH time-frequency resource units in the following at least one manner: in an ascending order of indexes of available DMRS ports on one PUSCH time-frequency resource unit, in an ascending order of indexes of PUSCH time-frequency resource units multiplexed in the frequency domain, or in an ascending order of indexes of PUSCH time-frequency resource units multiplexed in the time domain.

In one embodiment, the at least one processor is further configured to when the number of downlink beams mapped on one PUSCH time-frequency resource unit is N>1, divide the N_DMRS DMRS ports on the one PUSCH time-frequency resource unit into N_DMRS/N groups, and when the number of the downlink beams mapped on the one PUSCH time-frequency resource unit is N≤1, map all DMRS ports on the one PUSCH time-frequency resource unit to the downlink beam.

In one embodiment, the at least one processor is further configured to according to the determined transmission opportunity (RO) and a preamble on the RO, determine index information P_id of the preamble within a first predetermined time period, and according to the number N_PUSCHperssb of PUSCH time-frequency resource units corresponding to one downlink beam and/or the number N_DMRSperssb of DMRS ports on the PUSCH time-frequency resource units corresponding to the one downlink beam, and the index information P_id, determine index information TF_id and DMRS port information DMRS_id of the PUSCH time-frequency resource unit corresponding to the index information P_id within a second predetermined time period.

In another embodiment, a resource determination method of an electronic device is provided. The resource determination method may include obtaining resource configuration information of an uplink signal; based on the resource configuration information, obtaining first mapping information between a downlink beam and a random access channel (RACH) resource, and second mapping information between the downlink beam and a physical uplink shared channel (PUSCH) resource; according to the first mapping information and the second mapping information, obtaining RACH resource mapped with the determined downlink beam and PUSCH resource mapped with the determined downlink beam, and determining third mapping information between the RACH resource and the PUSCH resource; and according to the third mapping information and the determined RACH resource, determining available PUSCH resource.

In another embodiment, the obtaining the resource configuration information of the uplink signal may include obtaining the resource configuration information from at least one of: a random access feedback of a random access process, downlink control information of an uplink transmission, a radio resource control (RRC) configuration message, pre-configured parameter information, and a system message sent by a network side or other higher level control signaling.

In another embodiment, the resource configuration information may include at least one of four-step random access configuration information, two-step random access configuration information, downlink beam configuration information, and PUSCH resource configuration information.

In another embodiment, the determining the second mapping information between the downlink beam and the PUSCH resource may include at least one of: determining a mapping relationship between the downlink beam and PUSCH time-frequency resource; determining a mapping relationship between the downlink beam and a demodulation reference signal (DMRS) port; determining a mapping cycle from the downlink beam to the PUSCH resource; determining a mapping period from the downlink beam to the PUSCH resource; or determining a mapping pattern period from the downlink beam to the PUSCH resource.

In another embodiment, the determining the mapping relationship between the downlink beam and the PUSCH time-frequency resource may include: mapping indexes of all downlink beams configured within one downlink beam period to PUSCH time-frequency resource units in the following at least one manner: in an ascending order of indexes of available DMRS ports on one PUSCH time-frequency resource unit; in an ascending order of indexes of PUSCH time-frequency resource units multiplexed in the frequency domain; or in an ascending order of indexes of PUSCH time-frequency resource units multiplexed in the time domain.

In another embodiment, the determining the mapping relationship between the downlink beam and the DMRS port may include: when the number of downlink beams mapped on one PUSCH time-frequency resource unit is N>1, dividing the N_DMRS DMRS ports on one PUSCH time-frequency resource unit into N DMRSN groups, so that each of the downlink beams corresponds to one group of N DMRS/N groups; and when the number of downlink beams mapped on the one PUSCH time-frequency resource unit is N ^{C}1, mapping all DMRS ports on the one PUSCH time-frequency resource unit to this downlink beam.

In another embodiment, the PUSCH time-frequency resource unit may be a valid PUSCH time-frequency resource unit obtained based on a predetermined determination standard; the predetermined determination standard may be determined based on uplink and downlink configuration information and/or downlink beam configuration information configured by a network device, and may include at least one standard of the following standards: only the configured PUSCH time-frequency resource unit, located in the part indicated as uplink by the uplink and downlink configuration information within one uplink and downlink configuration period, are valid PUSCH time-frequency resource units; only the configured PUSCH time-frequency resource unit, located in the part indicated as non-downlink by the uplink and downlink configuration information within one uplink and downlink configuration period, are valid PUSCH time-frequency resource units; only the configured PUSCH time-frequency resource unit, after one or more time units after the part indicated as downlink by the uplink and downlink configuration information within one uplink and downlink configuration period, are valid PUSCH time-frequency resource units; and only the configured PUSCH time-frequency resource unit, after one or more time units after the last downlink beam in the downlink beam configuration information indicated by the uplink and downlink configuration information, within one uplink and downlink configuration period, are valid PUSCH time-frequency resource units.

In another embodiment, the determining the third mapping information between the RACH resource and the PUSCH resource may include: according to the determined transmission opportunity (RO) and a preamble on the RO, determining the index information P_id of the preamble within a first predetermined time period; and according to one of the number N_PUSCHperssb of PUSCH time-frequency resource units corresponding to one downlink beam and/or the number N_DMRSperssb of DMRS ports on the PUSCH time-frequency resource units corresponding to the one downlink beam, and the index information P_id, determining index information TF_id and DMRS port information DMRS_id of the PUSCH time-frequency resource unit corresponding to the index information P_id within a second predetermined time period.

In another embodiment, the determining the index information TF_id and the DMRS port information DMRS_id of the PUSCH time-frequency resource unit corresponding to the index information P_id within the second predetermined time period may include according to the index information P_id, determining the index information TF_id and the DMRS port information DMRS_id through the following equation:

$$P\_id = DMRS\_id \times N\_PUSCH p e r s s b + TF\_id$$

wherein TF_id ∈ {0˜N_PUSCHperssb−1}, DMRS_id ∈ {0˜N_DMRSperssb}, P_id ∈ {1˜N_roperssbXN_preambleperro−1}, wherein N_roperssb indicates the number of ROs corresponding to one downlink beam, and N_preambleperro indicates the number of preambles corresponding to one RO.

In another embodiment, the determining the index information TF_id and the DMRS port information DMRS_id of the PUSCH time-frequency resource unit corresponding to the index information P_id within the second predetermined time period may include: obtaining configuration information indicating that one PUSCH time-frequency resource unit corresponds to N_pp preambles; according to the index information P_id, determining the index information TF_id and the DMRS port information DMRS_id through the following equations:

$${P\_id}^{′} = f ( P\_id , N\_pp ) , \\ {P\_id}^{′} = y ( DMRS\_id , TF\_id )$$

wherein TF_id ∈ {0˜N_PUSCHperssb−1}, DMRS_id ∈ {0˜N_DMRSperssb}, P_id ∈ {0˜N_roperssb×N_preambleperro−1}, wherein N_roperssb indicates the number of ROs corresponding to one downlink beam, and N_preambleperro indicates the number of preambles corresponding to one RO, if N_pp≥1, then P_id′=f(P_id, N_pp)=└P_id/N_pp┘ or P_id mod(N_roperssb×N_preambleperro/N_pp), P_id′=y(DMRS_id, TF_id)=DMRS_id×N_PUSCHperssb+TF_id; if N_pp <1, then P_id′=f(P_id, N_pp)=P_id/N_pp+n_pp, wherein n_pp ∈ {0˜1/N_pp−1}, P_id′=y(DMRS_id, TF_id)=TF_idXN_DMRSperssb+DMRS_id, and one PUSCH time-frequency resource unit is selected from the determined 1/N_pp PUSCH time-frequency resource units with equal probability for sending uplink data.

In another embodiment, the first predetermined period may be one of a mapping cycle from downlink beam to the RACH resource, a configuration period of RACH resource, a mapping period from a downlink beam to the RACH resource, and a mapping pattern period from a downlink beam to the RACH resource. The second predetermined period may be one of a mapping cycle from a downlink beam to the PUSCH resource, a configuration period of the PUSCH resource, a mapping period from a downlink beam to the PUSCH resource, and a mapping pattern period from a downlink beam to the PUSCH resource.

In yet another embodiment, there is provided a resource determination device which may include: an acquisition unit configured to obtain resource configuration information of an uplink signal; a mapping relationship determination unit configured to based on the resource configuration information, obtain first mapping information between a downlink beam and random access channel (RACH) resource, and second mapping information between the downlink beam and physical uplink shared channel (PUSCH) resource; according to the first mapping information and the second mapping information, obtain the RACH resource mapped with the determined downlink beam and the PUSCH resource mapped with the determined downlink beam, and determine third mapping information between the RACH resource and the PUSCH resource; and a resource determination unit configured to determine available PUSCH resource according to the third mapping information and the determined RACH resource.

In yet another embodiment, the acquisition unit may be configured to obtain the resource configuration information from at least one of: a random access feedback of a random access process, downlink control information of an uplink transmission, a radio resource control (RRC) configuration message, pre-configured parameter information, and a system message sent by a network side or other higher level control signaling.

In yet another embodiment, the resource configuration information may include at least one of four-step random access configuration information, two-step random access configuration information, downlink beam configuration information, and PUSCH resource configuration information.

In yet another embodiment, the mapping relationship determination unit may be configured to determine the second mapping information between the downlink beam and the PUSCH resource by at least one of: determining a mapping relationship between the downlink beam and PUSCH time-frequency resource; determining a mapping relationship between the downlink beam and a demodulation reference signal (DMRS) port; determining a mapping cycle from the downlink beam to the PUSCH resource; determining a mapping period from the downlink beam to the PUSCH resource; and determining a mapping pattern period from the downlink beam to the PUSCH resource.

In yet another embodiment, the mapping relationship determination unit may be configure to determine a mapping relationship between the downlink beam and the PUSCH time-frequency resource, by mapping indexes of all downlink beams configured within one downlink beam period to PUSCH time-frequency resource units in the following at least one manner: in an ascending order of indexes of available DMRS ports on one PUSCH time-frequency resource unit; in an ascending order of indexes of PUSCH time-frequency resource units multiplexed in the frequency domain; and in an ascending order of indexes of PUSCH time-frequency resource units multiplexed in the time domain.

In yet another embodiment, the mapping relationship determination unit may be configured to determine the mapping relationship between the downlink beam and the DMRS port by: when the number of downlink beams mapped on one PUSCH time-frequency resource unit is N>1, dividing the N_DMRS DMRS ports on the one PUSCH time-frequency resource unit into N_DMRS/N groups, so that each of the downlink beams corresponds to one group of N_DMRS/N groups; and when the number of the downlink beams mapped on the one PUSCH time-frequency resource unit is N<1, mapping all DMRS ports on the one PUSCH time-frequency resource unit to this downlink beam.

In yet another embodiment, the PUSCH time-frequency resource unit may be a valid PUSCH time-frequency resource unit obtained based on a predetermined determination standard; the predetermined determination standard may be determined based on uplink and downlink configuration information and/or downlink beam configuration information configured by a network device, and includes at least one standard of the following standards: only the configured PUSCH time-frequency resource unit, located in the part indicated as uplink by the uplink and downlink configuration information within one uplink and downlink configuration period, are valid PUSCH time-frequency resource units; only the configured PUSCH time-frequency resource unit, located in the part indicated as non-downlink by the uplink and downlink configuration information within one uplink and downlink configuration period, are valid PUSCH time-frequency resource units; only the configured PUSCH time-frequency resource unit, after one or more time units after the part indicated as downlink by the uplink and downlink configuration information within one uplink and downlink configuration period, are valid PUSCH time-frequency resource units; and only the configured PUSCH time-frequency resource unit, after one or more time units after the last downlink beam in the downlink beam configuration information indicated by the uplink and downlink configuration information, within one uplink and downlink configuration period, are valid PUSCH time-frequency resource units.

In yet another embodiment, the mapping relationship determination unit may be configured to determine the third mapping information by: according to the determined transmission opportunity (RO) and a preamble on the RO, determining index information P_id of the preamble within the first predetermined time period; and according to one of the number N_PUSCHperssb of PUSCH time-frequency resource units corresponding to one downlink beam and/or the number N_DMRSperssb of DMRS ports on the PUSCH time-frequency resource units corresponding to the one downlink beam, and the index information P_id, determining index information TF_id and DMRS port information DMRS_id of the PUSCH time-frequency resource unit corresponding to the index information P_id within a second predetermined time period.

In yet another embodiment, the mapping relationship determination unit may be configured to according to the index information P_id, determine the index information TF_id and the DMRS port information DMRS_id through the following equation:

$$P\_id = DMRS\_id \times N\_PUSCH p e r s s b + TF\_id$$

wherein TF_id ∈ {0˜N_PUSCHperssb−1}, DMRS_id ∈ {0˜N_DMRSperssb}, P_id ∈ {0˜N_roperssb×N_preambleperro−1}, wherein N_roperssb indicates the number of ROs corresponding to one downlink beam, and N_preambleperro indicates the number of preambles corresponding to one RO.

Alternatively, the mapping relationship determination unit is configured to determine the index information TF_id and the DMRS port information DMRS_id by: obtaining configuration information indicating that one PUSCH time-frequency resource unit corresponds to N_pp preambles; according to the index information P_id, determining the index information TF_id and the DMRS port information DMRS_id through the following equations:

$${P\_id}^{′} = f ( P\_id , N\_pp ) , \\ {P\_id}^{′} = y ( DMRS\_id , TF\_id )$$

wherein TF_id ∈ {0˜N_PUSCHperssb−1}, DMRS_id ∈ {0˜N_DMRSperssb}, P_id ∈ {0˜N_roperssbXN_ preambleperro−1}, wherein N_roperssb indicates the number of ROs corresponding to one downlink beam, and N_preambleperro indicates the number of preambles corresponding to one RO, if N_pp≥1, then P_id′=f(P_id, N_pp)=└P_id/N_pp┘ or P_id mod(N_operssb×N_preambleperro/N_pp), P_id′=y(DMRS_id, TF_id)=DMRS_id×N_PUSCHperssb+TF_id, if N_pp<1, then P_id'=f(P_id, N_pp)=P_id/N_pp+n_pp, wherein n_pp ∈ {0˜N_pp−1}, P_id′=y(DMRS_id, TF_id)=TF_id×N_DMRSperssb+DMRS_id, and one PUSCH time-frequency resource unit is selected from the determined 1/N_pp PUSCH time-frequency resource units with equal probability for sending uplink data.

In yet another embodiment, the first predetermined period may be one of a mapping cycle from downlink beam to the RACH resource, a configuration period of RACH resource, a mapping period from a downlink beam to the RACH resource, and a mapping pattern period from the downlink beam to the RACH resource. The second predetermined period may be one of a mapping cycle from the downlink beam to the PUSCH resource, a configuration period of the PUSCH resource, a mapping period from the downlink beam to the PUSCH resource, and a mapping pattern period from the downlink beam to the PUSCH resource.

In accordance with another exemplary embodiment of the present disclosure, a computer readable storage medium storing instructions is provided, wherein the instructions, when performed by a computing device, enable the computing device to perform the resource determination method according to the aforementioned exemplary embodiment.

In accordance with another exemplary embodiment of the present disclosure, a user device is provided, which includes a processor and a memory for storing instructions that, when executed by the processor, cause the processor to perform the resource determination method according to the aforementioned exemplary embodiment.

Embodiments of the present disclosure will be described below by referring to the accompanying drawings. But it should be understood that these descriptions are only illustrative rather than limiting the scope of the present disclosure. In addition, the descriptions for the commonly known structure and technology are omitted in the following description to avoid unnecessary confusion of the concepts of the present disclosure.

Those skilled in the art may understand that the singular forms “a”, “an”, “said” and “the” used herein may also include the plural forms, unless specially stated. It should be further understood that the expression “include” and “comprise” used in the description of the present disclosure refer to the presence of the stated features, integers, steps, operations, elements and/or components, but does not exclude the presence or addition of one or more other features, integers, steps, operations, elements, components and/or their groups. It should be understood that when we call a element “connected” or “coupled” to another element, it can be directly connected or coupled to another element, or there may be an intermediate element. In addition, the “connection” or “coupling” used herein may include wireless connection or wireless coupling. The expression “and/or” used herein includes all or any one unit and all combinations of one or more associated listed items. The terms “transmit,” “receive,” and “communicate,” as well as derivatives thereof, encompass both direct and indirect communication. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “processor” or “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Those skilled in the art may understand that all terms used herein (including technical terms and scientific terms) have the same meaning as the general understanding of those ordinary skilled in the art to which the present disclosure belongs, unless otherwise defined. It should be further understood that terms, such as those defined in a general dictionary, should be understood to have the meanings consistent with those in the context of the prior art, and will not be interpreted with idealized or over formal meanings unless specifically defined like here.

Those skilled in the art may understand that the “terminal” and “terminal equipment” used herein include not only an equipment of a wireless signal receiver, which only is an equipment having a wireless signal receiver without a transmission ability, but also an equipment of receiving and transmitting hardware, which is an equipment having receiving and transmitting hardware capable of performing bidirectional communication on a bidirectional communication link. This equipment may include: a cellular or other communication device, which is a cellular or other communication device with a single line display or a multi-line display or without the multi-line display; PCS (personal communication system), which may combine voice, data processing, fax and/or data communication capabilities; PDA (Personal Digital Assistant), which may include a radio frequency receiver, a pager, an Internet/intranet access, a web browser, a notebook, a calendar and/or a GPS (Global Positioning System) receiver; and a conventional laptop and/or handheld computer or other equipment, which is a conventional laptop and/or handheld computer or other equipment having and/or including a radio frequency receiver. The “terminal” and “terminal equipment” used herein may be portable, transportable or installed in transportation (aviation, shipping and/or land transportation), or suitable and/or configured to operate locally and/or operate at any other location on earth and/or in space in a distributed form. The “terminal” and “terminal equipment” used here may also be a communication terminal, an Internet terminal and a music/video playing terminal, for example may be a PDA, a MID (Mobile Internet Device) and/or a mobile phone with a music/video playing function, may also be a smart TV, a set-top box and the like.

The time domain unit (also called a time unit) in the present disclosure may be: one OFDM symbol, one OFDM symbol group (composed of multiple OFDM symbols), one time slot, one time slot group (composed of multiple time slots), one subframe, one subframe group (composed of multiple subframes), one system frame, one system frame group (composed of multiple system frames); may also be an absolute time unit, such as lms, ls, etc.; the time unit may also be a combination of multiple granularities, such as N1 time slots plus N2 OFDM symbols.

The frequency domain unit in the present disclosure may be: one subcarrier, one subcarrier group (composed of multiple subcarriers), one resource block (RB) which is also known as a physical resource block (PRB), one resource block group (composed of multiple RBs), one frequency band part (BWP), one frequency band part group (composed of multiple BWPs), one frequency band/carrier, one frequency band group/carrier group; may also be an absolute frequency domain unit, such as 1 Hz, 1 kHz, etc.; the frequency domain unit may also be a combination of multiple granularities, such as M1 PRBs plus M2 subcarriers.

In order to make the purpose, technical means and advantages of the present application clearer, the present application is further described in detail below in combination with the drawings and specific embodiments.

Transmission in the radio communication system includes: a transmission from a base station (gNB) to a user equipment (UE) (called as a downlink transmission) with the corresponding time slot being called as a downlink time slot, and a transmission from the UE to the base station (called as an uplink transmission) with the corresponding time slot being called as an uplink time slot.

In a downlink communication of the radio communication system, the system periodically sends a synchronization signal and a broadcast channel to a user through a synchronizing signal block (SSB), the period being a synchronizing signal block period (SSB period) or called as a synchronizing signal block group period (SSB group period). Meanwhile, the base station may configure a random access configuration period (PRACH configuration period), within which a certain amount of random access transmission opportunities (also called as a random access opportunity (RO)) are configured, and all of SSBs being mapped onto the corresponding ROs within a mapping period (that is, a certain time length) is satisfied.

In a new radio (NR) communication system, before a radio resource control is established, for example, in the random access process, the random access performance can directly affect user experience. In a traditional radio communication system, such as LTE and LTE-Advanced, a random access process is applied to a plurality of scenes, such as establishing an initial connection, cell handover, re-establishing uplink connections and radio resource control (RRC) connection reconstruction, etc., and according to whether the user has exclusive preamble resource, the random access process is divided into competition-based random access and non-competition-based random access. Since in the competition-based random access, respective users may select preambles from the same preamble resource in the process of attempting to establish an uplink connection, and there may be cases where multiple users select the same preamble to be sent to the base station, a conflict resolution mechanism is an important research direction in random access, and how to reduce the probability of conflict and how to quickly resolve the conflicts that have occurred are key indicators affecting the random access performance.

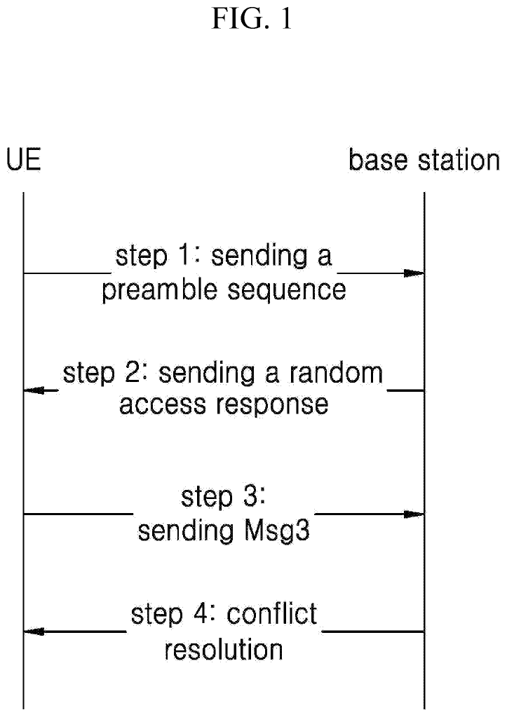

FIG. 1 is a diagram illustrating a competition-based random access process in LTE-A according to embodiments of the present disclosure.

As shown in FIG. 1, the competition-based random access process in LTE-A is divided into four steps. In the first step, a user randomly selects a preamble from a preamble resource pool and sends it to a base station. The base station performs correlation detection on the received signals, so as to recognize the preamble sent by the user. In the second step, the base station sends a random access response (RAR) to the user, including a random access preamble identifier, a timing advance instruction determined according to the time delay estimation between the user and the base station, a temporary cell radio network temporary identification (C-RNTI), and a time-frequency resource allocated for the next uplink transmission of the user. In the third step, the user sends a third message (Msg3) to the base station according to information in the RAR. Msg3 includes information such as a user terminal identification and a RRC link request and the like, wherein the user terminal identification is unique for the user and used for resolving conflicts. In the fourth step, the base station sends a conflict resolution identification to the user, including the user terminal identification of the winner in the conflict resolution. After detecting the user's own identification, the user upgrades the temporary C-RNTI to C-RNTI, sends an ACK signal to the base station, completes the random access process, and waits for the scheduling by the base station. Otherwise, the user will start a new random access process after a delay.

For the non-competition based random access process, since the base station has known the user identification, a preamble may be allocated to the user. Therefore, when sending the preamble, the user does not need to randomly select a sequence, but may use the allocated preamble. After detecting the allocated preamble, the base station may send a corresponding random access response, including information such as timing advance, uplink resource allocation and the like. After receiving the random access response, the user considers that an uplink synchronization has been completed and waits for a further scheduling by the base station. Therefore, the non-competition based random access process may only include two steps: the first step sending the preamble; and the second step sending the random access response.

The random access process in LTE is applicable to the following scenes:

1. initial access under RRC IDLE;

2. re-establishing RRC connection;

3. cell handover;

4. downlink data arriving and requesting random access process in the RRC connection state (when the uplink is out of synchronization);

5. uplink data arriving and requesting random access process in the RRC connection state (when the uplink is out of synchronization, or no resource allocated to the scheduling request in PUCCH resource); and

6. positioning.

In order to meet a huge traffic demand, a 5G communication system is expected to work in resource from a low-frequency band to a high-frequency band of about 100G, including licensed and unlicensed frequency bands. A 5GHz frequency band and a 60GHz frequency band of the unlicensed frequency bands are mainly considered. We call the 5G system working in the unlicensed frequency band as an NR-U system, which may include scenes working independently in the unlicensed frequency band, scenes working through a manner of dual connection (DC) with the licensed frequency band, and scenes working through a manner of carrier aggregation (CA) with the licensed frequency band. In the 5GHz frequency band, the 802.11 series of wireless fidelity (WiFi) system, the radar and LTE licensed carrier assisted access (LAA) system have been deployed. They all follow a mechanism of Listen Before Tall (LBT), that is, the radio channel must be detected before sending a signal, and only when the radio channel is detected to be idle, can the radio channel be occupied for sending the signal. In the 60GHz frequency band, the 802.1lay system has also existed, thus, it is also necessary to follow the LBT mechanism. In other unlicensed frequency bands, a valid coexistence mode shall be formulated according to corresponding specifications.

The LBT mechanism may be divided into two types. One of the two types may be called as the first type of LBT, which is generally called Category 4 LBT (TS 36.213 15.2.1.1), which determines a conflict window size (CWS) and randomly generates a backoff factor X. If X carrier monitoring time slots (CCA time slots) are all idle, a signal may be sent. The first type of LBT may be divided into four LBT priority categories, which correspond to different QCIs, respectively. For different LBT priority categories, CWS sizes may be different (that is, value sets of CW are different), fallback time units (which are equal to 16+9Xn microseconds, n is an integer greater than or equal to 1) may be different, and the maximum channel occupation time (MCOT) may be also different. The other of the two types may be called as the second type of LBT (TS 36.213 15.2.1.2), wherein the transmitter only needs to carry out a 25 us clear channel assessment (CCA) detection once before the start of the standard defined transmission signal. If the channel is free, it may send a signal.

In some communication systems (licensed spectrum and/or unlicensed spectrum), in order to achieve faster signal transmission and reception, the random access preamble may be considered to be transmitted together with the data part (the random access preamble and the data part are represented as message A), and then the feedback from the network device (represented as message B) may be searched in the downlink channel. However, how to configure the resource of the random access preamble and the data part in the sent message A to make the base station better detect that the message A sent by the user is a problem necessary to be solved.

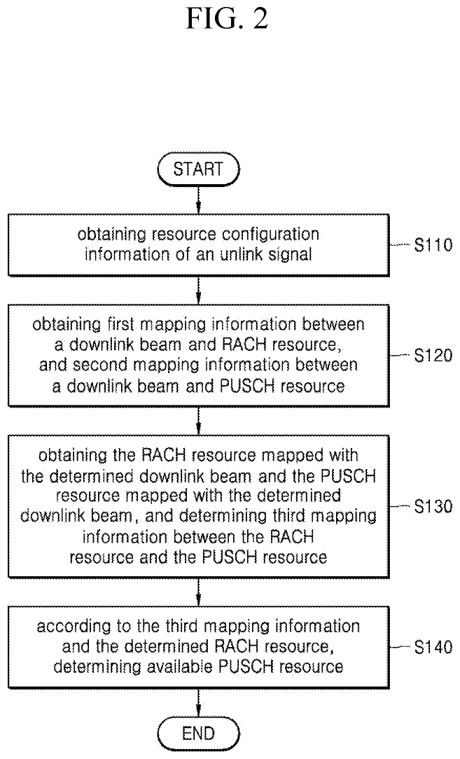

FIG. 2 is a flow diagram illustrating a resource determination method according to embodiments of the present disclosure.

Referring to FIG. 2, in step S110, the UE may obtain resource configuration information of an uplink signal. Specifically speaking, in this embodiment, the UE may obtain the resource configuration information of the uplink signal from the network side and/or pre-configured information, wherein the obtaining the resource configuration information of the uplink signal by the UE may include obtaining the resource configuration information from at least one of:

1. random access feedback (RAR) of a random access process, such as uplink grant (UL grant) information therein;

2. downlink control information of the scheduled uplink transmission, such as the uplink grant (UL grant) information or separate downlink control information (DCI) configuration therein, wherein the scheduled uplink transmission may be new transmission of data and may also be retransmission of data;

3. system information or other higher layer signaling such as a RRC configuration message obtained by the UE from network and the like; and

4. pre-configured parameter information.

The resource configuration information may include at least one of four-step random access configuration information, two-step random access configuration information, downlink beam configuration information, and PUSCH resource configuration information. The above information that may be included in the resource configuration information will be described in detail below.

The four-step random access configuration information (that is, conventional random access configuration information) includes at least one of:
a four-step PRACH configuration period (P_4STEPRACH);
a four-step random access opportunity time unit index, such as a slot index, a symbol index, a subframe index, etc.;
a four-step random access opportunity frequency domain unit index, such as a carrier index, a shared bandwidth packet (BWP) index, a physical resource block (PRB) index, a subcarrier index, etc.;
the number of four-step random access opportunities;
a four-step random access preamble format, such as a cyclic prefix (CP) length, a length and the repetition number of a preamble sequence, a guard interval (GT) length, a used subcarrier interval size, etc.;
the number of four-step random access preambles, an index of a root sequence and a cyclic shift value;
the number of synchronous signal blocks (SSBs) that may be mapped on one four-step random access opportunity (4STEPRO);
one or more channel status information reference signal (CSI-RS) indexes for a four-step random access;
the number of 4STEPRO mapped by one CSI-RS;
one or more 4STEPRO indexes mapped by one CSI-RS;
The two-step random access configuration information may include at least one of:
a two-step PRACH configuration period (P_2STEPRACH);
a two-step random access opportunity time unit index, such as a slot index, a symbol index, a subframe index, etc.;
a two-step random access opportunity frequency domain unit index, such as a carrier index, a BWP index, a PRB index, a subcarrier index, etc.;
the number of two-step random access opportunities;
a two-step random access preamble format, such as a CP length, a length and the repetition number of a preamble sequence, a GT length, a used subcarrier interval size, etc.;
the number of two-step random access preambles, an index of a root sequence and a cyclic shift value;
the number of SSBs that may be mapped on one two-step random access opportunity (2STEPRO);
one or more CSI-RS indexes for a two-step random access;
the number of 2STEPRO mapped by one CSI-RS; and
one or more 2STEPRO indexes mapped by one CSI-RS.

In addition, if the above described parameters in the two-step random access configuration information are not separately configured, the UE may determine the two-step random access configuration information according to the relative relationship of corresponding parameters in the four-step random access configuration information, for example, the UE may perform a certain calculation on the four-step PRACH configuration period and a predefined or configured extension parameter to obtain the two-step PRACH configuration period.
The downlink beam (for example, SSB and/or CSI-RS) configuration information may include at least one of:
a downlink beam period size;
the number of downlink beams sent within one downlink beam period;
indexes of downlink beams sent within one downlink beam period;
time unit positions of downlink beams sent within one downlink beam period; and
frequency domain unit positions of downlink beams sent within one downlink beam period.

The PUSCH resource configuration information (that is, data resource configuration information of the two-step random access) may include at least one of PUSCH time-frequency resource configuration information and DMRS resource configuration information, wherein one PUSCH resource unit may be composed of one PUSCH time-frequency resource unit and one DMRS port resource, wherein:

The PUSCH time-frequency resource configuration information includes at least one of:
the size of one or more PUSCH time-frequency resource units (i.e., the size of time-frequency resource corresponding to one two-step random access preamble, including M time units and N frequency-domain units; if there are multiple PUSCH time-frequency resource units in the PUSCH time-frequency resource configuration information, the sizes of different PUSCH time-frequency resource units may be different, i.e., the value(s) of M and/or N are/is different due to difference of PUSCH time-frequency resource units), wherein the size of a PUSCH time-frequency resource unit may be determined by looking up a table;
a PUSCH time-frequency resource configuration period (P_PUSCH);
a time unit index of a PUSCH time-frequency resource units, such as a slot index, a symbol index, a subframe index, etc.;
a frequency domain unit index of a PUSCH time-frequency resource units, such as a carrier index, a BWP index, a PRB index, a subcarrier index, etc.;
a time domain starting position of the PUSCH time-frequency resource;
a frequency domain starting position of the PUSCH time-frequency resource;
the number of PUSCH time-frequency resource units (or the number of PUSCH time-frequency resource units in time domain and/or the number of PUSCH time-frequency resource units in frequency domain are respectively configured);
a PUSCH time-frequency resource unit format, such as repetition times, a GT length, a guard frequency-domain blank (GB), etc.;
the number of downlink beams that may be mapped on one PUSCH time-frequency resource unit;
one or more downlink beam indexes for two-step random access PUSCH transmission;
the number of PUSCH time-frequency resource units mapped with one downlink beam;
indexes of one or more PUSCH time-frequency resource units mapped with one downlink beam.

The DMRS resource configuration information may include at least one of:
the number N_DMRS and/or indexes of DMRS ports available on one PUSCH time-frequency resource unit (i.e., each DMRS port correspondingly has its own port configuration information);
The DMRS port configuration information, including at least one of:
i. a sequence type, for example, used to indicate whether it is a ZC sequence, a gold sequence, etc.;
ii. a cyclic shift interval;
iii. a length (i.e. a subcarrier/subcarriers occupied by a DMRS sequence);
iv. a time domain orthogonal covering code (TD-OCC), for example, TD-OCC with a length of 2 may be [+1 −1], [−1,+1];
v. a frequency domain orthogonal covering code (FD-OCC), for example, FD-OCC with a length of 2 may be [+1 −1], [−1,+1];
vi. a comb configuration, including a comb size and/or a comb offset. For example, if the comb size is 4 and the comb offset is 0, then it means the 0th resource unit (RE) of every 4 REs in the DMRS sequence, and if the comb size is 4 and the comb offset is 1, then it means the 1st RE of every 4 REs in the DMRS sequence.

Through step S110, the UE may obtain the resource configuration information of the uplink signal. How the UE obtains respective mapping information according to the obtained resource configuration information will be described below in detail.

In step S120, the UE may obtain a first mapping information between the downlink beam and the RACH resource and a second mapping information between the downlink beam and the PUSCH resource based on the resource configuration information. The RACH resource may include an RO and/or a preamble, and the RO may include a four-step random access RO and/or a two-step random access RO.

Preferably, when to map the downlink beam with the RACH resource and/or to map the RACH resource with the PUSCH resource, wherein the RACH resource does not include the last part RACH resource within one time period, that is, the UE considers that the last part RACH resource within the one time period is invalid, and/or is not used for mapping the downlink beam with the RACH resource and/or mapping the RACH resource with the PUSCH resource, that is, not selected by the UE; wherein:
the one time period may be at least one of:
   one time unit or a group of continuous time units, such as one time slot or one system frame;
in an uplink and downlink configuration period configured in the unpaired spectrum; if multiple uplink and downlink configuration periods are configured by a system, the one time period represents any one or all of the uplink and downlink configuration periods;
PRACH configuration period;
   the last part RACH resource may be at least one of:
      RACH resource (a random access opportunity and/or a random access preamble) in the last slot or last N slots of the one time period; where N is a value predefined or configured by the system;
      Within one time period, a RACH resource who has a gap between its ending position and the starting position of the next (the nearest) downlink part and/or the next (the nearest) SSB which is larger or not smaller than a threshold pre-set or configured by network;
   preferably, the UE may not be expected to be configured to a RACH resource configuration having the last part RACH resource within the one time period. For example, in the paired spectrum, the base station may configure random those access resource that do not include the last part RACH resource within the one time period;

Below the downlink beam being SSB and/or CSI-RS is taken as an example to describe the process of obtaining the first mapping information and the second mapping information in detail.

The first mapping information between the downlink beam and the RACH resource may include mapping information between the SSB and the RACH resource and mapping information between the CSI-RS and the RACH resource. The mapping information between the SSB and the RACH resource includes at least one of:
a mapping period from the SSB to the RO, for example, the number of PRACH configuration periods required for completing at least one mapping from the SSB to the RO;
a mapping pattern period from the SSB to the RO, for example, a time length to ensure that the mappings from the SSB to the RO within adjacent two mapping pattern periods are totally the same, the number of the mapping periods from the SSB to the RO required for the ensuring, or the number of PRACH configuration periods required for the ensuring;

Similarly, the mapping information between the CSI-RS and the RACH resource may include at least one of:
a mapping period from the CSI-RS to the RO, for example, the number of PRACH configuration periods required for completing all mappings from the CSI-RS to the RO within at least one CSI-RS period;
a mapping pattern period from the CSI-RS to the RO, for example, a time length to ensure that the mappings from the CSI-RS to the RO within adjacent two mapping pattern periods are totally the same, the number of the mapping periods from the CSI-RS to the RO required for the ensuring, or the required number of PRACH configuration periods required for the ensuring.

In the above step S120, the UE may further obtain the second mapping information between the downlink beam and the PUSCH resource based on the resource configuration information, that is, the PUSCH resource for the two-step random access configured by the base station may be obtained. The obtaining the second mapping information between the downlink beam and the PUSCH resource may include at least one of: determining a mapping relationship between the downlink beam and PUSCH time-frequency resource; determining a mapping relationship between the downlink beam and DMRS port; determining a mapping cycle from the downlink beam to the PUSCH resource; determining a mapping period from the downlink beam to the PUSCH resource; and determining a mapping pattern period from the downlink beam to the PUSCH resource. Below it is described in detail.

The determining the mapping relationship between the downlink beam and the PUSCH time-frequency resource may include mapping indexes of all downlink beams configured within one downlink beam (take the SSB as an example) period to the configured PUSCH resource in the following order by using at least one manner of: first, in an ascending order of indexes of available DMRS ports on one PUSCH time-frequency resource unit; second, in an ascending order of the configured indexes of PUSCH time-frequency resource units multiplexed in one of the frequency domain and the time domain; third, in an ascending order of the configured indexes of PUSCH time-frequency resource units multiplexed in the other of the time domain and the frequency domain.

The determining the mapping relationship between the downlink beam and the DMRS port may include: when the number of downlink beams (taking the SSB as an example) mapped on one PUSCH time-frequency resource unit is N>1, dividing N_DMRS DMRS ports on the one PUSCH time-frequency resource unit into N_DMRS/N groups, so that each of the downlink beams (taking the SSB as an example) may correspond to one group of N_DMRS/N groups, wherein N DMRS/N may be ensured to be a positive integer by a configuration at the network side or may be ensured to a positive integer by being rounded; when N≤1, all DMRS ports on the one PUSCH time-frequency resource unit are mapped to this downlink beam, specifically, one downlink beam (taking the SSB as an example) is mapped to 1/N PUSCH time-frequency resource units, wherein all DMRS ports of each PUSCH time-frequency resource unit may be also mapped to this downlink beam.

The mapping cycle from the downlink beam to the PUSCH resource may represent the length of time-frequency resource (for example, the number of OFDM symbols, the number of time slots, etc.) of fully mapping all the downlink beams (taking the SSB as an example) configured within one downlink beam period (taking the SSB as an example) to the corresponding two-step random access PUSCH resource. The mapping cycle from the downlink beam to the PUSCH resource may also be called as the complete mapping from the downlink beam to PUSCH of two-step random access.

The mapping period from the downlink beam to the PUSCH, for example, may represent the number of the PUSCH of two-step random access required for completing at least one completely mapping the downlink beam (taking the SSB as an example) to the PUSCH of two-step random access.

The mapping pattern period from the downlink beam to the PUSCH may represent, for example, a time length to ensure that the mappings from the downlink beams (taking the CSI-RS as an example) to the PUSCHs of two-step random access within the adjacent two mapping pattern periods are totally the same, the number of the mapping periods from the downlink beam (taking CSI-RS as an example) to the PUSCH of two-step random access required for the ensuring, or the number of PRACH configuration periods required for the ensuring.

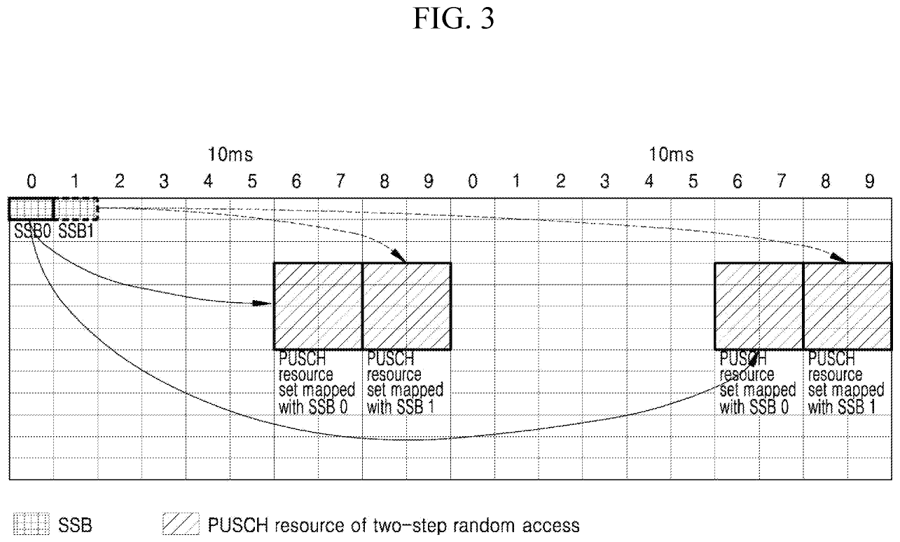

Below the process for mapping the downlink beam to the PUSCH resource is described with reference to FIG. 3 and with the SSB as an example.

FIG. 3 is a mapping diagram of SSB to PUSCH resource according to embodiments of the present disclosure.

As shown in FIG. 3, the SSB period may be 20ms, two SSBs (i.e., SSB 0 and SSB 1) may be transmitted in each SSB period, the PUSCH period may be 10 ms (i.e., P_PUSCH=10 ms). There may be 16 PUSCH time-frequency resource units in each PUSCH period, and there may be available 12 DMRS ports on one PUSCH time-frequency resource unit. 1/8 SSB may be mapped onto one PUSCH time-frequency resource unit (that is, one SSB may be mapped to eight PUSCH time-frequency resource units). The mapping operation of mapping the PUSCH resource to the SSB may be completed using a method of first with respect to DMRS port, then with respect to frequency domain and finally with respect to time domain during the mapping. “First with respect to DMRS port” may refer to mapping one SSB to all of DMRS ports on 8 PUSCH time-frequency resource units in present example, that is, the DMRS ports may be not necessary to be grouped. As such, SSB 0 may be mapped to the former 8 PUSCH time-frequency resource units (and DMRS ports thereof) within one period, and SSB 1 may be mapped to the latter 8 PUSCH time-frequency resource units (and DMRS ports thereof) within the one period. In the example of FIG. 3, the mapping cycle from the SSB to the PUSCH may start from the first PUSCH time-frequency resource unit which SSB 0 is mapped to the last PUSCH time-frequency resource unit which SSB1 is mapped to. The mapping period from the SSB to the PUSCH resource of two-step random access may be one PUSCH configuration period (P_PUSCH), and the mapping pattern period of the SSB to the PUSCH of two-step random access may be a mapping period from one SSB to the PUSCH of two-step random access.

In addition, all of the above PUSCH time-frequency resource units for mapping with the downlink beam may be valid PUSCH time-frequency resource units obtained based on a predetermined determination standard. The predetermined determination standard may be determined by the UE based on the uplink and downlink configuration information and/or the downlink beam configuration information configured by a network device, and may include at least one of the following four standards:

determination standard 1: only the configured PUSCH time-frequency resource units, located in the part indicated as uplink by the uplink and downlink configuration information within one uplink and downlink configuration period, are valid PUSCH time-frequency resource units;

determination standard 2: only the configured PUSCH time-frequency resource units, located in the part indicated as non-downlink by the uplink and downlink configuration information within one uplink and downlink configuration period, are valid PUSCH time-frequency resource units;

determination standard 3: only the configured PUSCH time-frequency resource units, after one or more time units after the part indicated as downlink by the uplink and downlink configuration information within one uplink and downlink configuration period, are valid PUSCH time-frequency resource units; and

determination standard 4: only the configured PUSCH time-frequency resource unit, after one or more time units after the last SSB in the SSB configuration information indicated by the uplink and downlink configuration information, within one uplink and downlink configuration period, are valid PUSCH time-frequency resource units.

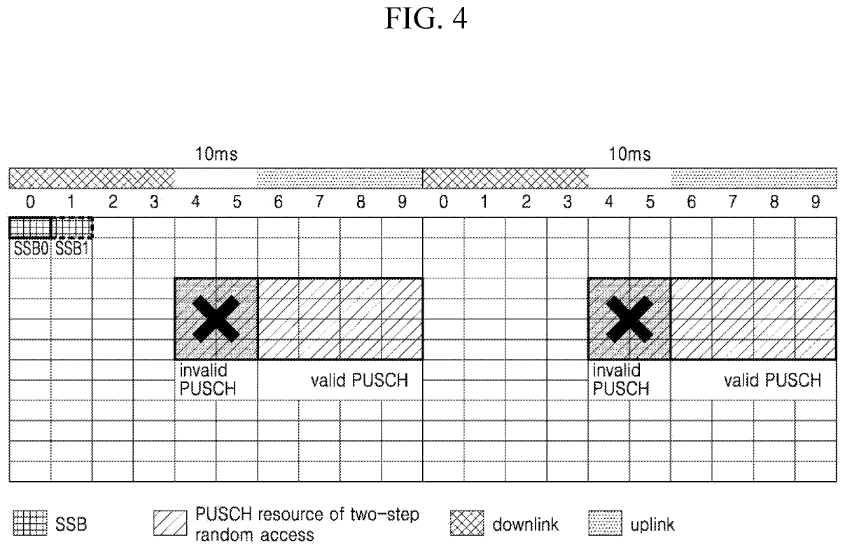

Below how to determine a valid PUSCH time-frequency resource unit is described in detail with reference to FIG. 4.

FIG. 4 is a diagram of valid PUSCH resource according to embodiments of the present disclosure.

As shown in FIG. 4, when a start position of PUSCH resource starts from time slot 4 to time slot 9, but an uplink part in an uplink and downlink configuration starts from time slot 6 to time slot 9, valid PUSCH resource may be obtained according to the determination standard 1 within one two-step random access PUSCH resource configuration period, then the PUSCH resource of two-step random access on time slots 4 and 5 may be invalid PUSCH resource, and the PUSCH resource of two-step random access on time slots 6-9 may be the valid PUSCH resource, thereby obtaining valid PUSCH time-frequency resource units and corresponding DMRS ports thereof.

After steps S110 and S120, the UE may obtain the first mapping information between the downlink beam and the RACH resource and the second mapping information between the downlink beam and the PUSCH resource. After that, in step S130, the UE may, according to the first mapping information and the second mapping information, obtain the RACH resource mapped with the determined downlink beam and the PUSCH resource mapped with the determined downlink beam, and determine a third mapping information between the RACH resource and the PUSCH resource.

Specifically speaking, when the UE determines an index of a downlink beam (taking the SSB as an example), for example, when the UE determines the index of the SSB through a downlink measure and a configured threshold value, or the UE directly determines the index of the SSB according to downlink control information (DCI) or a high-level signaling from the network side, the UE may obtain available RACH resource and PUSCH resource corresponding to the index of the SSB (for example, two-step random access RACH resource and PUSCH resource). The RACH resource may include the RO and the preamble, and the PUSCH resource may include the PUSCH time-frequency resource and the DMRS port resource.

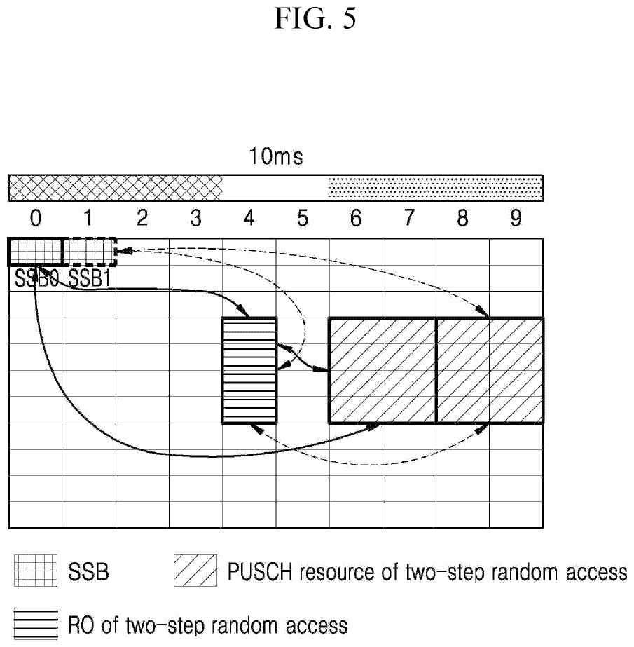

FIG. 5 is a mapping diagram between the RACH resource mapped with the same downlink beam and the PUSCH resource mapped with the same downlink beam according to embodiments of the present disclosure.

As shown in FIG. 5, the UE may obtain the RACH resource mapped with the determined downlink beam and the PUSCH resource mapped with the determined downlink beam, and determine third mapping information between the RACH resource and the PUSCH resource. Below the downlink beam being the SSB is taken as an example to describe the process of determining the third mapping information in detail.

Specifically speaking, the UE may determine the third mapping information between the RACH resource and the PUSCH resource through the following operations: according to the determined transmission opportunity (RO) and the preamble on the RO, determining the index information P_id of the preamble within a first predetermined time period; and according to one of the number N PUSCHperssb of PUSCH time-frequency resource units corresponding to one downlink beam and/or the number N DMRSperssb of DMRS ports on the PUSCH time-frequency resource units corresponding to the one downlink beam, and the index information P_id, determining index information TF_id and DMRS port information DMRS_id of a PUSCH time-frequency resource unit corresponding to the index information P id within a second predetermined time period.

More specifically speaking, the UE may determine the third mapping information between the RACH resource mapped with the determined downlink beam and the PUSCH resource mapped with the determined downlink beam through at least one of the following two manners, that is, the third mapping information between the available RACH resource and PUSCH resource corresponding to the same one SSB index.

Manner 1: according to the determined RO and a preamble on the RO, the UE may determine the index information P_id of the preamble within the first predetermined time period, where P_id ∈ {0˜N_roperssb×N_preambleperro−1}, where N_roperssb indicates the number of ROs corresponding to one downlink beam, and N_preambleperro indicates the number of preambles corresponding to one RO. According to the index information P_id, the UE may determine the index information TF_id and the DMRS port information DMRS_id of a PUSCH time-frequency resource unit corresponding to the index information P_id within the second predetermined time period, through the following equation (1):

$$P\_id = DMRS\_id \times N\_PUSCH p e r s s b + TF\_id \qquad ( 1 )$$

wherein TF_id ∈ {0˜N_PUSCHperssb−1}, N_PUSCHperssb may represent the number of PUSCH time-frequency resource units corresponding to one downlink beam. The first predetermined time period may be one of a mapping cycle from the downlink beam to the RACH resource (e.g. the SSB to the RO), a configuration period of the RACH, a mapping period from the downlink beam to the RACH resource (e.g. the SSB to the RO), and a mapping pattern period from the downlink beam to the RACH resource (e.g. the SSB to the RO). The second predetermined time period may be one of a mapping cycle from the downlink beam to the PUSCH resource (e.g. the SSB to the PUSCH resource), a configuration period of the PUSCH resource, a mapping period from the downlink beam to the PUSCH resource (e.g. the SSB to the PUSCH resource), and a mapping pattern period from the downlink beam to the PUSCH resource (e.g. the SSB to PUSCH). Specially, an index of a PUSCH resource unit may be firstly defined as DMRS_idXN_PUSCHperssb+TF_id, and then P_id and the index of the PUSCH resource unit may be mapped. Next, the first predetermined time period being the mapping cycle from the downlink beam to the RACH resource (e.g., the SSB to the RO) and the second predetermined period being the mapping cycle from the downlink beam to the PUSCH resource (e.g., the SSB to the PUSCH) are taken as examples for detailed description.

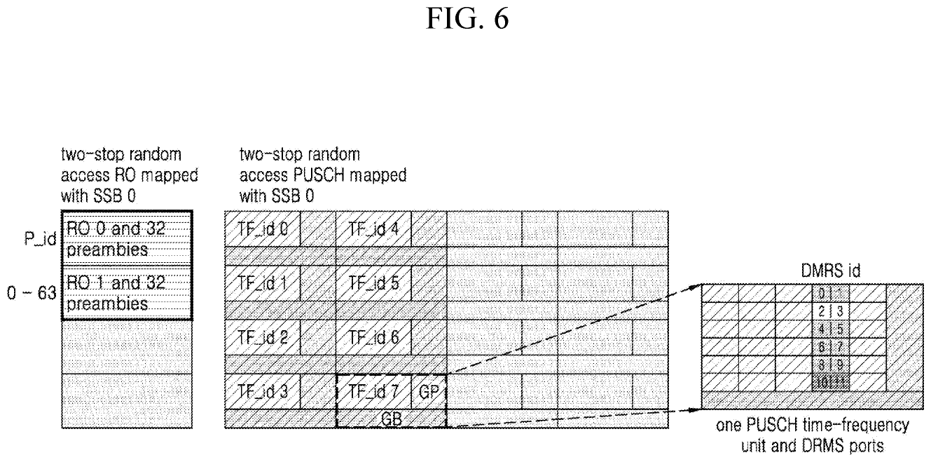

FIG. 6 is a mapping diagram between the RACH resource mapped with the same downlink beam and the PUSCH resource mapped with the same downlink beam according to embodiments of the present disclosure.

As shown in FIG. 6, all of preambles corresponding to the same one SSB within one mapping cycle (of SSB to RO) may be represented as P_id ∈ {0˜N_roperssb×N_preambleperro−1}, for example, one SSB within the mapping cycle may correspond to N_roperssb=two ROs, and there may be N_preambleperro=32 preambles on each of the ROs, that is, the number of all preambles may be 64, then P_id ∈ {0,1,2, . . . ,63}. P_id may be reset with the mapping cycle (of SSB to RO) as a period, that is, P_id may start from 0 again within one new mapping cycle. All PUSCH time-frequency resource units corresponding to the same one SSB within a mapping cycle (of SSB to PUSCH) may be represented as TF_id ∈ {0˜N_PUSCHperssb-1}, and DMRS ports on one PUSCH time-frequency resource unit corresponding to the SSB may be represented as DMRS_id ∈ {0˜N_DMRSperssb−1}, for example, one SSB within one mapping cycle may correspond to N_PUSCHperssb=8 PUSCH time-frequency resource units, then TF_id ∈ {0˜7}, at this moment, all DMRS ports of each PUSCH time-frequency resource unit may be also mapped to this SSB, that is, N_DMRSperssb=N_DMRS. N_DMRS=12 may be the number of all DMRS ports configured on one PUSCH time-frequency resource unit; that is, DMRS_id ∈ {0˜11}. The UE may obtain the corresponding P_id through the selected RO and preamble, and calculate the corresponding DMRS_id and TF_id by the obtained P_id and the above equation (1), that is, the UE may find the corresponding PUSCH time-frequency resource unit (TF_id) of two-step random access and the DMRS port (DMRS_id) used on the PUSCH time-frequency resource unit according to the selected two-step random access RO and two-step random access preamble through the above described mapping rule. In the present example, the mapping rule may be P_id=DMRS_idX8+TF_id, for example, according to P_id=23 which is obtained according to the RO selected by the UE and the preamble on this RO, the UE can determine that the position of corresponding PUSCH time-frequency resource for sending two-step random access PUSCH is the PUSCH time-frequency resource unit corresponding to TF_id=7 the DMRS port corresponding to DMRS_id=2.

In addition, P_id selected by the UE may correspond to index information RO_id of a RO selected by the UE and index information preamble_id of a preamble in the RO, as shown in the above example, RO_id ∈ {0˜N_roperssb−1}, that is, {0˜1}, preamble_id ∈ {0˜N_preambleperro−1}, that is, {0˜31}. Then P_id=RO_idXN_preambleperro+preamble_id.

In addition, when N_roperssb×N_preambleperro is larger than N_DMRSperssb×N_PUSCHperssb, that is, X=N_roperssb×N_preambleperro−N_DMRSperssb×N_PUSCHperssb, the UE may perform one of the following processes:

using the latter [W/N_roperssb] preambles of preambles corresponding to each RO as invalid preambles, that is, the selection of P_id does not consider the latter [X/N_roperssb] preambles, wherein [] represents a rounding up or down operation;

using the latter X preambles in P_id as invalid preambles, that is, P_id ∈ {0˜min(N_roperssb×N_preambleperro, N_DMRSperssb×N_PUSCHperssb)};

recalculating P_id with respect to the extra X preambles, that is, if P_id selected by the UE is greater than N_DMRSperssbXN_PUSCHperssb−1, making P_id=P_id mod (N_DMRSperssb×N_PUSCHperssb), wherein mod is the mathematical modular operation; for example, if N_DMRSperssb×N_PUSCHperssb=96, N_roperssbXN_preambleperro=100, and X=4, when P_id selected by the UE is 97, since P_id>95, P_id =97 mod 96=1 which will be used to P_id=DMRS_id×N PUSCHperssb+TF_id by the UE, thus, at this moment, the position of corresponding PUSCH time-frequency resource for sending two-step random access PUSCH is the PUSCH time-frequency resource unit corresponding to TF_id=1 and the DMRS port corresponding to DMRS_id=0 is determined;

evenly allocating the extra X preambles to each RO to recalculate P_id, for example, if N_roperssb=2, N_preambleperro=50, N_DMRSperssb=12, and N_PUSCHperssb=8, the number of the available PUSCH resource unit (constituted by one PUSCH time-frequency resource unit and one DMRS port resource) is 96, 48 preambles may be mapped to each RO, and then there are extra N_preambleperro-W=2 preambles on each RO, wherein W=N_DMRSperssbXN_PUSCHperssb/N_roperssb, thus, at this moment, P_id=P_id=RO_idXN_preambleperro+preamble_id mod (W).

The determining the third mapping information between the RACH resource mapped with the determined downlink beam and the PUSCH resource mapped with the determined downlink beam (that is, available RACH resource and PUSCH resource corresponding to the same one SSB index) by the UE through the manner 1 is described as above. Besides, the UE may further determine the third mapping information between the RACH resource mapped with the determined downlink beam and the PUSCH resource mapped with the determined downlink beam through another manner 2, which is described in detail below.

Manner 2: The UE may obtain configuration information indicating that one PUSCH time-frequency resource unit corresponds to N_pp premables, and then according to the determined RO and the preamble on the RO, may determine the index information P_id of the preamble within the first predetermined time period, where P_id ∈ {0˜N_roperssb×N_preambleperro−1}, where N_roperssb indicates the number of ROs corresponding to one downlink beam, and N_preambleperro indicates the number of preambles corresponding to one RO. In the above description, the UE may first obtain the configuration information, and then determine the index information P_id, however, the UE may first determine the index information P_id, and then obtain the configuration information, or the UE may determine the index information P_id and obtain the configuration information at the same time.

After that, according to the index information P_id, the UE may determine the index information TF_id and the DMRS port information DMRS_id of the PUSCH time-frequency resource unit corresponding to the index information P_id within the second predetermined time period through the following equations (2) and (3):

$$\begin{matrix}{P\_id}^{′} = f ( P\_id , N\_pp ) & equation ( 2 ) \\ {P\_id}^{′} = y ( DMRS\_id , TF\_id ) & equation ( 3 )\end{matrix}$$

wherein TF_id ∈ {0˜N_PUSCHperssb−1}, DMRS_id ∈ {0˜N_DMRSperssb}.

If N_pp≥1, then P_id′=f(P_id, N_pp)=└P_id/N_pp┘ or P_id mod(N_roperssb×N_preambleperro/N_pp), and P_id′=y(DMRS_id, TF_id)=DMRS_id×N_PUSCHperssb+TF_id, wherein N_roperssb represents the number of ROs corresponding to one downlink beam, and N_preambleperro represents the number of preambles corresponding to one RO.

if N_pp<1, then P_id′=f(P_id, N_pp)=P_id/N_pp+n_pp, wherein n_pp ∈ {0˜1N_pp−1}, and P_id′=y(DMRS_id, TF_id)=TF_idXN_DMRSperssb+DMRS_id, and one PUSCH time-frequency resource unit may be selected from the determined 1/N_pp PUSCH time-frequency resource units with equal probability.

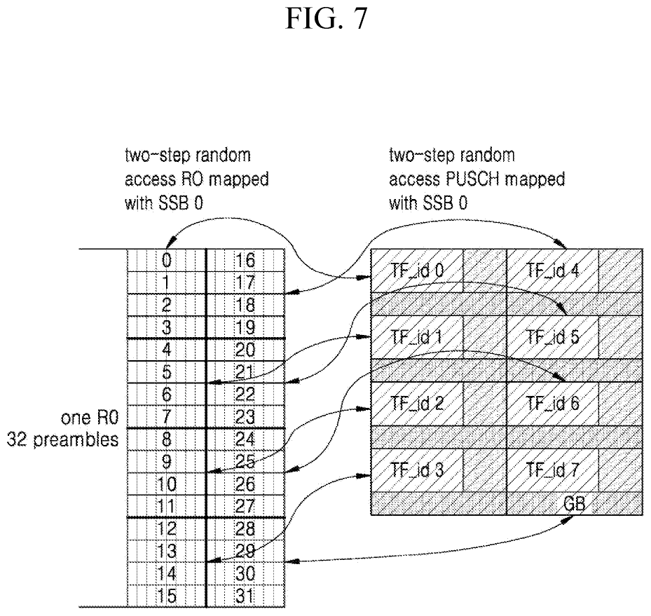

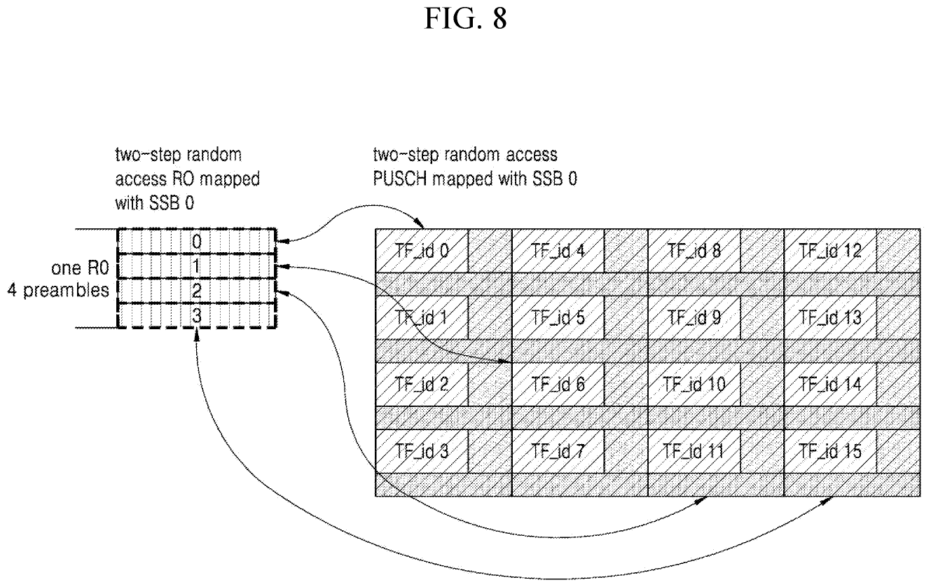

The first predetermined time period may be one of a mapping cycle from the downlink beam to the RACH resource (e.g. the SSB to the RO), a configuration period of the RACH, a mapping period from the downlink beam to the RACH resource (e.g. the SSB to the RO), and a mapping pattern period from the downlink beam to the RACH resource (e.g. the SSB to the RO). The second predetermined time period may be one of a mapping cycle from the downlink beam to the PUSCH resource (e.g. the SSB to the PUSCH resource), a configuration period of the PUSCH resource, a mapping period from the downlink beam to the PUSCH resource (e.g. the SSB to the PUSCH resource), and a mapping pattern period from the downlink beam to the PUSCH resource (e.g. the SSB to PUSCH resource). Specially, an index of a PUSCH resource unit may be firstly defined as DMRS_idXN_PUSCHperssb+TF_id or TF_idXN_DMRSperssb+DMRS_id, and then P_id and the index of the PUSCH resource unit may be mapped. Next, the first predetermined time period being the mapping cycle from the downlink beam to the RACH resource (e.g., the SSB to the RO) and the second predetermined period being the mapping cycle from the downlink beam to the PUSCH resource (e.g., the SSB to the PUSCH resource) may be taken as examples for detailed description. Below the detailed description is presented with reference to FIGS. 7 and 8. The UE may obtain configuration information in which N_pp preambles may be mapped to one PUSCH resource unit (that is, 1/N PUSCH resource units may be mapped to one preamble); that is, at this moment, all preambles corresponding to the SSB index selected or configured by the UE in one mapping cycle (of SSB to RO) may be represented as P_id ∈ {0˜N_roperssbXN_preambleperro−1}, for example, P_id ∈ {0,1,2, . . . ,63} in the example described by referring to FIG. 6, all PUSCH time-frequency resource units corresponding to the SSB index in one mapping cycle (of SSB to PUSCH resource) may be represented as TF_id ∈ {0˜N_PUSCHperssb−1}, DMRS ports on one PUSCH time-frequency resource unit corresponding to the SSB may be represented as DMRS_id ∈ {0˜N_DMRSperssb−1}, for example, in the example described by referring to FIG. 6, TF_id ∈ {0˜7}, and DMRS_id ∈ {0˜11}, then at this moment, the number of configured total preambles may be 64, and [64/N_pp] PUSCH time-frequency resource units may be needed to complete the mapping between the preambles and the PUSCH resource.

FIG. 7 is a diagram of mapping a plurality of preambles to one PUSCH resource unit according to embodiments of the present disclosure.

When N_pp>=1, that is, N_pp preambles are mapped to the same one PUSCH resource unit (that is, the same one PUSCH time-frequency resource unit and the same DMRS port), then P_id' may be determined according to one of the following methods:
Method 1: mapping continuous N_pp preambles to the same one PUSCH resource unit, then at this moment, P_id,′=f(P_id, N_pp)=└P_id/N_pp┘, wherein └x┘ represents the maximum integer smaller than x, that is, rounding down; for example, if N_pp=4, when the UE initially selects P_id=0,1,2,3, since └0/4┘=└1/4┘=└2/4┘=└3/4┘=0, P_id′ finally used in P_id′=y(DMRS_id, TF_id)=DMRS_idXN_USCHperssb+TF_id is 0. As shown in

FIG. 7, the continuous four preambles are mapped to the same PUSCH resource unit.
Method 2: mapping the preambles with an interval of N_operssbXN_preambleperro/N_pp to the same one PUSCH resource unit, then at this moment, P_id′=f(P_id, N_pp)=P_id mod (N_roperssb×N_preambleperro/N_pp); for example, if N_pp=4, when the UE initially selects P id=0,16,32,48, since 0 mod 16=16 mod 16=32 mod 16=48 mod 16=0, P_id′ finally used in P_id′=y(DMRS_id, TF_id)=DMRS_id×N_PUSCHperssb+TF_id is 0.

FIG. 8 is a diagram of mapping one preamble to a plurality of PUSCH resource units according to embodiments of the present disclosure.

When N_pp<1, that is, one preamble is mapped to N_pp PUSCH resource units, P_id′ may be determined according to one of the following methods:
Method 1: as shown in FIG. 8, mapping one preamble to continuous N_pp PUSCH resource units (first continuous PUSCH time-frequency resource units, then continuous DMRS ports), then at this moment, P_id′=f(P_id, N_pp)=P_id/N_pp+n_pp, n_pp ∈ {0˜1/N_pp-1}, for example, if 1/N_pp=4, when the UE initially selects P_id =0, since P id′=0X4+{0, 1, 2, 3}={0, 1, 2, 3}, P_id′ finally used in P_id′=y(DMRS_id, TF_id)=DMRS_idXN_PUSCHperssb+TF_id may be {0, 1, 2, 3}, and the UE selects one therefrom with equal probability, in other words, the UE selects one from N_pp PUSCH resource units to which initial P_id=0 is mapped, with equal probability.
Method 2: mapping one preamble to continuous N_pp PUSCH resource units (first continuous DMRS ports, then continuous PUSCH time-frequency resource units), then at this moment, P_id′=P_id/N_pp+n_pp, and the calculation equation of the P_id′ is P_id′=y(DMRS_id, TF_id)=TF_id×N DMRSperssb+DMRS_id, n_pp ∈ {0˜1/N_pp−1}, for example, if 1/N_pp=4, when the UE initially selects P_id=0, since P id′=0X4+{0, 1, 2, 3}={0, 1, 2, 3}, P_id′ finally used in P_id′=y(DMRS_id, TF_id)=TF_id×N DMRSperssb+DMRS_id may be {0, 1, 2, 3}, and the UE selects one therefrom with equal probability, in other words, the UE selects one from N_pp PUSCH resource units to which initial P id=0 is mapped, with equal probability.

In addition, specially, P_id selected by the UE may correspond to index information RO_id of the RO selected by the UE and index information preamble_id of a preamble in the RO, as shown in the above example, RO_id ∈ {0˜N_roperssb−1}, that is, {0˜1}, preamble_id ∈ {0˜N_preambleperro−1}, that is, {0˜31}, thus, P_id=RO_id×N_preambleperro+preamble_id.

Specially, the definition of the mapping cycle from the RACH resource to the PUSCH resource may represent the length of time-frequency resource (for example, the number of OFDM symbols, the number of time slots, etc.) of fully mapping the RACH resource, within first predetermined time period (taking a mapping cycle as an example) from the downlink beam to the RACH resource, to the PUSCH resource of corresponding two-step random access. The mapping cycle from the RACH resource to the PUSCH resource may also be called as a complete mapping from the RACH resource to the PUSCH resource of two-step random access. When the UE determines the third mapping information between the RACH resource mapped with the determined downlink beam and the PUSCH resource mapped with the determined downlink beam through the manner 1 or the manner 2, the above method mat be that mapping the RACH resource within first predetermined time period (taking a mapping cycle as an example) from the downlink beam to the RACH resource to the PUSCH resource within second predetermined time period (taking a mapping cycle as an example) from the downlink beam to the PUSCH resource only has one mapping cycle from the RACH resource to the PUSCH resource by default; if the PUSCH resource within one mapping cycle from the downlink beam to the PUSCH resource is more than the PUSH resource required by one mapping cycle from the RACH resource to the PUSCH resource, it may be processed through at least one manner of:

1. when the other PUSCH resource units in the PUSCH resource in one mapping cycle from the downlink beam to the PUSCH resource, expect the PUSCH resource units in the first mapping cycle from the RACH resource to the PUSCH resource, is not enough to form one mapping cycle from the RACH resource to the PUSCH resource, the other PUSCH resource units in the PUSCH resource in one mapping cycle from the downlink beam to the PUSCH resource, expect the PUSCH resource units in the first mapping cycle from the RACH resource to the PUSCH resource, are considered as unavailable PUSCH resource units, that is, being not mapped with the RACH resource, and that is, ensuring the mapping the RACH resource in one mapping cycle from the downlink beam to the RACH resource to the PUSCH resource in one mapping cycle from the downlink beam to the PUSCH resource to only have one mapping cycle from the RACH resource to the PUSCH resource;

2. the other PUSCH resource units in the PUSCH resource in one mapping cycle from the downlink beam to the PUSCH resource, expect the PUSCH resource units in the first mapping cycle from the RACH resource to the PUSCH resource, are considered as unavailable PUSCH resource units, that is, being not mapped with the RACH resource, and that is, ensuring the mapping the RACH resource in one mapping cycle from the downlink beam to the RACH resource to the PUSCH resource in one mapping cycle from the downlink beam to the PUSCH resource to only have one mapping cycle from the RACH resource to the PUSCH resource;

3. when the mapping the RACH resource in one mapping cycle from the downlink beam to the RACH resource to the PUSCH resource in one mapping cycle from the downlink beam to the PUSCH resource may have N>1 mapping cycles from the RACH resource to the PUSCH resource, resetting indexes of PUSCH resource units in one mapping cycle from the RACH resource to the PUSCH resource, that is, the PUSCH resource units are ordered from index 0. The other PUSCH resource units in the PUSCH resource in one mapping cycle from the downlink beam to the PUSCH resource, expect the PUSCH resource units in N mapping cycles from the RACH resource to the PUSCH resource, are considered as unavailable PUSCH resource units, that is, the other PUSCH resource units are not mapped with the RACH resource.

In another embodiment of the present disclosure, TF_id may be further resolved into a time domain t id and a frequency domain fid, and when the mapping parameter N_pp is obtained by the UE (optimally, the mapping parameter may be obtained by the UE through the number of available random access resource and available data resource obtained within a certain period), then

P_id′=f(P_id, N_pp)=└P_id/N_pp┘. wherein └x┘ represents the maximum integer smaller than x, that is, rounding down, for example, if N_pp=4, when the UE initially selects P_id=0,1,2,3, since , └0/4┘=└1/4┘=└2/4┘=└3/4┘=0, N_pp continuous preambles are mapped to one PUSCH resource unit; or

then at this moment, P_id′=f(P_id, N_pp)=P id mod (N_preamble/N_pp); wherein N_preamble represents the number of all of available preambles within a time domain period, for example, if N_pp=4, when the UE initially selects P_id=0,16,32,48, since 0 mod 16=16 mod 16=32 mod 16=48 mod 16=0, preambles with the interval N_preamble/N_pp may be mapped to the same one PUSCH resource unit;

and then through

$${P\_id}^{′} = y ( DMRS\_id , f\_id , t\_id ) = f\_id + {N\_f}^{*} DMRS\_id + {N\_f}^{*} {( 1 + N\_DMRS )}^{*} t\_id , \\ or$$

$${P\_id}^{′} = y ( DMRS\_id , f\_id , t\_id ) = f\_id + {N\_f}^{*} t\_id + {N\_f}^{*} {( 1 + N\_t )}^{*} DMRS\_id ,$$

unique DMRS_id, fid and t_id are derived, wherein f_id is a frequency domain index of the PUSCH time-frequency resource unit used for sending message A PUSCH, that is, f_id ∈ {0˜N_f-1}, and N_f is the number of PUSCH time-frequency resource units in the frequency domain configured by the base station, or the maximum number of PUSCH time-frequency resource units configurable in the frequency domain;

DMRS_id may be a DMRS resource index of the DMRS resource used for sending message A PUSCH on the PUSCH time-frequency resource unit, that is, DMRS_id ∈ {0˜N_DMRS-1}, N DMRS may be the number of DMRS resource configured on one PUSCH time-frequency resource unit, or the maximum number of configurable DMRS resource configured on one PUSCH time-frequency resource unit, optimally, the number of DMRS resource may be the number of DMRS ports x the number of DMRS sequences (optimally, which may be scrambled IDs);

t_id may be the index value in the set of PUSCH time-frequency resource units which is derived by all valid random access resource in the time domain within one time domain period, in PUSCH time-frequency resource units for sending message A. That is, t_id∈ {0˜N_t-1}, N_t may be the number of PUSCH time-frequency resource units in the time domain derived from all valid random access resource in the time domain in the one time domain period, wherein the one time domain period may be at least one of:

1. one or one group of ROs in a random access time slot;

2. one group of continuous random access time slots;

3. one or one group of continuous random access time slots to the next or the next group (the closest one or one group) of continuous random access time slots;

4. PRACH configuration period, a mapping cycle of SSB toRO, a mapping period of SSB to RO, or a mapping pattern period of SSB to RO;

optimally, the above PUSCH time-frequency resource unit may be a valid and/or usable PUSCH time-frequency resource unit.

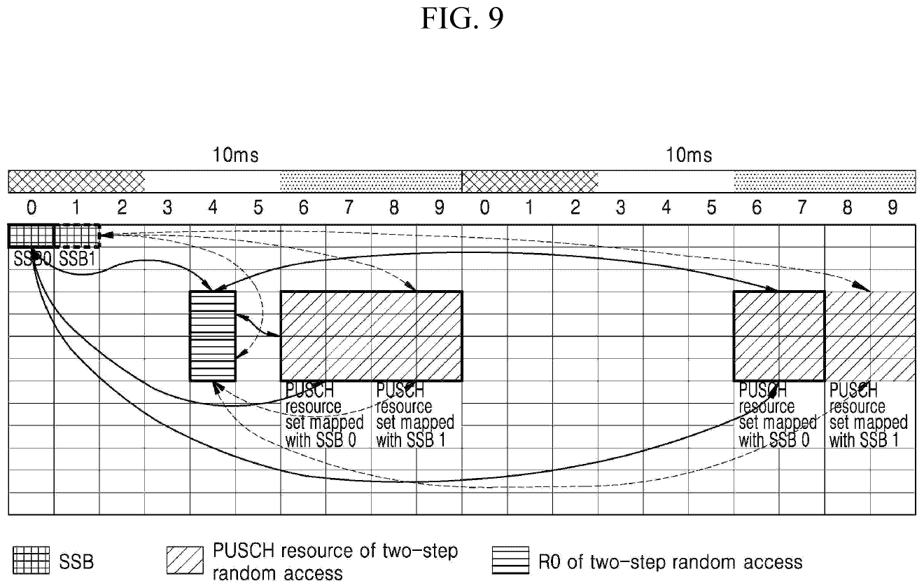

FIG. 9 is a diagram illustrating determining available PUSCH resource through an interval value according to embodiments of the present disclosure.

According to the above received configuration information and the mapping relationship setting, the UE can find the available PUSCH resource (PUSCH time-frequency resource units and DMRS ports) through the determined (selected) two-step random access RO and preamble and then through the mapping relationship. If N>1 PUSCH resource is found, the UE may select one PUSCH resource therefrom with equal probability to perform the corresponding PUSCH transmission.

Specially, among the available PUSCH resource found by the UE through the determined (selected) two-step random access RO and preamble as well as the mapping relationship, the first (group) available PUSCH resource may be determined according to an gap value (GAP). The gap value may be determined by the network side through high-level signaling, a system message, or a downlink control signaling configuration, or may be determined by the user equipment itself, such as the UE's own processing capability; that is, only the available PUSCH resource after the gap value GAP after the two-step random access RO determined by the UE can be determined as the truly available PUSCH resource by the UE; as shown in FIG. 9, if gap value GAP=3 slots, a user who selects a RO corresponding to SSB 0 cannot use the PUSCH resource in the first PUSCH resource set mapped with SSB 0 in the FIG. 9 for transmission, because the PUSCH resource set mapped with this SSB 0 is not after the determined RO+GAP (i.e., is partially overlapping with the determined RO+GAP time range), it can be used for this transmission (but it is still valid PUSCH resource), but a user who selects a RO corresponding to SSB 1 may use the PUSCH resource in the first PUSCH resource set mapped with SSB 1 for transmission.

Through above step S130, the UE may determine the third mapping information between the RACH resource mapped with the determined downlink beam and the PUSCH resource mapped with the determined downlink beam (that is, the available RACH resource and PUSCH resource corresponding to the same one SSB index). Therefore, in step S140, the UE may determine the available PUSCH resource according to the third mapping information and the determined RACH resource, that is, after selecting the RACH resource (i.e., the RO and the preamble), the UE may determine the available PUSCH resource according to the third mapping information and the selected RACH resource, and then send the preamble and PUSCH (i.e., message A) to the network side, after that, the UE may search a possible two-step random access feedback in a control information search space configured by the network; if feedback information includes a correct conflict resolution identifier, it may indicate that the preamble and the PUSCH of the UE are correctly detected and decoded by the base station.

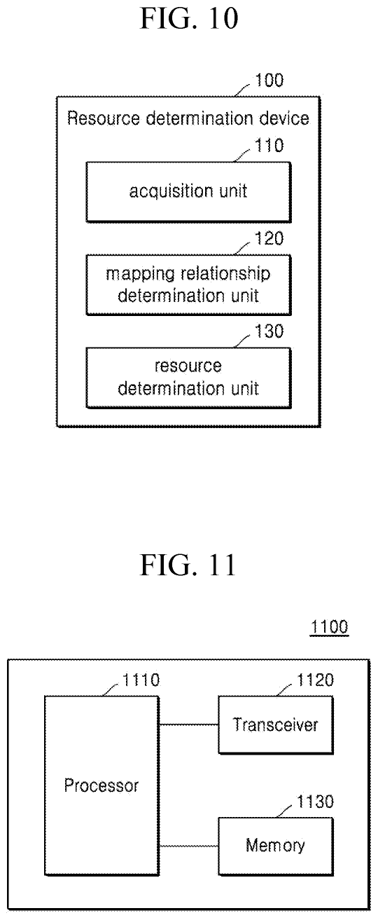

FIG. 10 is a block diagram illustrating a resource determination device according to embodiments of the present disclosure.

In the exemplary embodiment of the present disclosure, the resource determination device 100 may be implemented at the user equipment (UE) side.

Referring to FIG. 10, the resource determination device 100 in accordance with an exemplary embodiment of the present disclosure may include an acquisition unit 110, a mapping relationship determination unit 120 and a resource determination unit 130.

The acquisition unit 110 may be configured to obtain resource configuration information of an uplink signal.

The mapping relationship determination unit 120 may be configured to based on the resource configuration information, obtain first mapping information between a downlink beam and random access channel (RACH) resource, and second mapping information between the downlink beam and a physical uplink shared channel (PUSCH); and according to the first mapping information and the second mapping information, obtain RACH resource mapped with the determined downlink beam and PUSCH resource mapped with the determined downlink beam, and determine third mapping information between the RACH resource and the PUSCH resource.

The resource determination unit 130 may be configured to determine the available PUSCH resource according to the third mapping information and the determined RACH resource.

The details of respective operations that the acquisition unit 110, the mapping relationship determination unit 120 and the resource determination unit 130 described above may perform are described above in detail in combination with respective operations of FIGS. 1 to 8, thus, they are not described any more here for conciseness.

FIG. 11 illustrates a resource determination device according to embodiments of the present disclosure.

Referring to the FIG. 11, the electronic device 1100 for resource determination may include a processor 1110, a transceiver 1120 and a memory 1130. However, all of the illustrated components are not essential. The electronic device 1100 may correspond to a resource determination device 100 of FIG. 10. The electronic device 1100 may be implemented by more or less components than those illustrated in FIG. 11. In addition, the processor 1110 and the transceiver 1120 and the memory 1130 may be implemented as a single chip according to another embodiment.

The aforementioned components will now be described in detail.

The processor 1110 may include one or more processors or other processing devices that control the proposed function, process, and/or method. Operation of the device 1100 may be implemented by the processor 1110.

In one embodiment, the processor 1110 may obtain the resource configuration information of the uplink signal. Based on the resource configuration information, the processor 1110 may obtain first mapping information between a downlink beam and a random access channel (RACH) resource, and second mapping information between a downlink beam and physical uplink shared channel (PUSCH) resource. According to the first mapping information and the second mapping information, the processor 1110 may obtain RACH resource mapped with the determined downlink beam and PUSCH resource mapped with the determined downlink beam, and determine third mapping information between the RACH resource and the PUSCH resource. According to the third mapping information and the determined RACH resource, the processor may determine available PUSCH resource.

The transceiver 1120 may include a RF transmitter for up-converting and amplifying a transmitted signal, and a RF receiver for down-converting a frequency of a received signal. However, according to another embodiment, the transceiver 1120 may be implemented by more or less components than those illustrated in components.

The transceiver 1120 may be connected to the processor 1110 and transmit and/or receive a signal. The signal may include control information and data. In addition, the transceiver 1120 may receive the signal through a wireless channel and output the signal to the processor 1110. The transceiver 1120 may transmit a signal output from the processor 1110 through the wireless channel.

The memory 1130 may store the control information or the data included in a signal obtained by the electronic device 1100. The memory 1130 may be connected to the processor 1110 and store at least one instruction or a protocol or a parameter for the proposed function, process, and/or method. The memory 1130 may include read-only memory (ROM) and/or random access memory (RAM) and/or hard disk and/or CD-ROM and/or DVD and/or other storage devices.

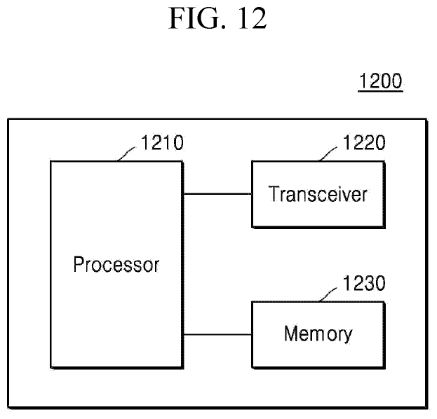

FIG. 12 illustrates a user equipment (UE) according to embodiments of the present disclosure.

Referring to the FIG. 12, the UE 1200 may include a processor 1210, a transceiver 1220 and a memory 1230. However, all of the illustrated components are not essential. The UE 1200 may be implemented by more or less components than those illustrated in FIG. 12. In addition, the processor 1210 and the transceiver 1220 and the memory 1230 may be implemented as a single chip according to another embodiment.

The aforementioned components will now be described in detail.

The processor 1210 may include one or more processors or other processing devices that control the proposed function, process, and/or method. Operation of the UE 1200 may be implemented by the processor 1210.

The processor 1210 may obtain resource configuration information of an uplink signal. Based on the resource configuration information, the processor 1210 may obtain first mapping information between a downlink beam and a random access channel (RACH) resource, and second mapping information between a downlink beam and physical uplink shared channel (PUSCH) resource. According to the first mapping information and the second mapping information, the processor 1210 may obtain RACH resource mapped with the determined downlink beam and PUSCH resource mapped with the determined downlink beam, and determine third mapping information between the RACH resource and the PUSCH resource. According to the third mapping information and the determined RACH resource, the processor may determine available PUSCH resource.

The transceiver 1220 may include a RF transmitter for up-converting and amplifying a transmitted signal, and a RF receiver for down-converting a frequency of a received signal. However, according to another embodiment, the transceiver 1220 may be implemented by more or less components than those illustrated in components.

The transceiver 1220 may be connected to the processor 1210 and transmit and/or receive a signal. The signal may include control information and data. In addition, the transceiver 1220 may receive the signal through a wireless channel and output the signal to the processor 1210. The transceiver 1220 may transmit a signal output from the processor 1210 through the wireless channel.

The memory 1230 may store the control information or the data included in a signal obtained by the UE 1200. The memory 1230 may be connected to the processor 1210 and store at least one instruction or a protocol or a parameter for the proposed function, process, and/or method. The memory 1230 may include read-only memory (ROM) and/or random access memory (RAM) and/or hard disk and/or CD-ROM and/or DVD and/or other storage devices.

The present disclosure further provides a computer readable medium, on which computer executable instructions are stored, wherein when operated by a computer device, the instructions enable the computer device to perform the resource configuration method described in the present embodiment.

The present disclosure further provides a user equipment, which may include a processor and a memory storing instructions, wherein when executed by the processor, the instructions enable the processor to execute the resource determination method described in the present embodiment.

“User equipment” or “UE” herein may refer to any terminal with a wireless communication capability, including but not limited to a mobile phone, a cellular phone, a smart phone or a personal digital assistant (PDA), a portable computer, an image capture apparatus(such as a digital camera), a game apparatus, a music storage and playback apparatus, and any portable unit or terminal with a wireless communication capability, or Internet facilities that allow wireless Internet access and browse.

The term “base station” (B S) or “network device” used herein may refer to eNB, eNodeB, NodeB or a base station transceiver (BTS) or gNB and the like according to the used technologies and terms.

The “computer readable medium” herein may be any type suitable for the technical environment of the present disclosure, and may be implemented by using any suitable data storage technology, including but not limited to a semiconductor based storage device, a magnetic memory device and system, an optical memory device and system, a fixed memory and a removable memory.

The above content is only a better embodiment of the present disclosure and is not used to limit the present disclosure. Any modification, equivalent replacement, improvement and the like made within the spirit and principles of the present disclosure shall be included within the protection scope of the present disclosure.

Those skilled in the art may understand that the present disclosure includes apparatuses involved for performing one or more of the operations described in the present application. These apparatuses may be specially designed and manufactured for the required purpose, or may also include known devices in general computers. These apparatuses have computer programs stored therein, and these computer programs are selectively activated or reconstructed. Such computer programs may be stored in an apparatus (e.g., a computer) readable medium or in any type of medium suitable for storing electronic instructions and coupled to a bus, respectively, and the computer readable medium includes but not limited to any type of disk (including a soft disk, a hard disk, an optical disk, a CD-ROM, and a magneto-optical disk), ROM (Read-Only Memory), RAM (Random Access Memory), EPROM (Erasable Programmable Read-Only Memory), EEPROM (Electrically Erasable Programmable Read-Only Memory), flash memory, magnetic card or light card. That is, the readable medium includes any medium in which information is stored or transmitted in a readable form by an apparatus (e.g., a computer).

Those skilled in the art may understand that each block in these structure diagrams and/or block diagrams and/or flow diagrams and combinations of blocks in these structure diagrams and/or block diagrams and/or flow diagrams may be implemented using computer program instructions. Those skilled in the art may understand that these computer program instructions may be provided to general computers, special computers or processors of other programmable data processing methods to be implemented, thereby carrying out the solutions designated in one or more blocks of structure diagrams and/or block diagrams and/or flow diagrams disclosed by the present disclosure through computers or processors of other programmable data processing methods.

Those skilled in the art may understand that steps, measurements and solutions in various operations, methods and flows that have been discussed in the present disclosure may be alternated, changed, combined or deleted. Furthermore, other steps, measures and solutions having various operations, methods and flows that have been discussed in the present disclosure may be alternated, changed, combined or deleted. Furthermore, steps, measures and solutions in the prior art having the steps, measures and solutions in various operations, methods and flows that have been disclosed in the present disclosure may be alternated, changed, combined or deleted.

The above statements are only partial embodiments of the present disclosure, it should be pointed out that, to those ordinary skilled in the art, several improvements and retouches can also be made without departing from the principle of the present disclosure, also those improvements and retouches should be considered as the protection scope of the present disclosure.

1. An electronic apparatus for resource determination, the electronic apparatus comprising:
a transceiver; and
at least one processor operably connected to the transceiver, the at least one processor configured to:
obtain resource configuration information of an uplink signal;
based on the resource configuration information, obtain first mapping information between a downlink beam and a random access channel (RACH) resource, and second mapping information between the downlink beam and a physical uplink shared channel (PUSCH) resource;
according to the first mapping information and the second mapping information, obtain the RACH resource mapped with the downlink beam and the PUSCH resource mapped with the downlink beam, and determine third mapping information between the RACH resource and the PUSCH resource; and
determine an available PUSCH resource according to the third mapping information and the determined RACH resource.

2. The electronic apparatus of claim 1, wherein the resource configuration information comprises the resource configuration information from at least one of:
a random access feedback of a random access process, downlink control information of scheduled uplink transmission, a radio resource control (RRC) configuration message, pre-configured parameter information, or a system message sent by a network side or other higher level control signaling.

3. The electronic apparatus of claim 1, wherein the resource configuration information comprises at least one of: four-step random access configuration information, two-step random access configuration information, downlink beam configuration information, or PUSCH resource configuration information.

4. The electronic apparatus of claim 1, wherein the at least one processor is further configured to:
determine a mapping relationship between the downlink beam and a PUSCH time-frequency resource;
determine a mapping relationship between the downlink beam and a demodulation reference signal (DMRS) port;
determine a mapping cycle from the downlink beam to the PUSCH resource;
determine a mapping period from the downlink beam to the PUSCH resource; and
determine a mapping pattern period from the downlink beam to the PUSCH resource.

5. The electronic apparatus of claim 4, wherein the mapping relationship between the downlink beam and the PUSCH time-frequency resource comprises indexes of all downlink beams configured within one downlink beam period to PUSCH time-frequency resource units in the following at least one manner:
in an ascending order of indexes of available DMRS ports on one PUSCH time-frequency resource unit;
in an ascending order of indexes of PUSCH time-frequency resource units multiplexed in the frequency domain; or
in an ascending order of indexes of PUSCH time-frequency resource units multiplexed in the time domain.

6. The electronic apparatus of claim 4, wherein the at least one processor is further configured to:
when a number of downlink beams mapped on one PUSCH time-frequency resource unit is N>1, divide N_DMRS DMRS ports on the one PUSCH time-frequency resource unit into N_DMRS/N groups; and
when the number of the downlink beams mapped on the one PUSCH time-frequency resource unit is N≤1, map all DMRS ports on the one PUSCH time-frequency resource unit to the downlink beam.

7. The electronic apparatus of claim 1, wherein the at least one processor is further configured to:
according to a determined transmission opportunity (RO) and a preamble on the RO, determine index information P_id of the preamble within a first predetermined time period; and
according to a number N_PUSCHperssb of PUSCH time-frequency resource units corresponding to one downlink beam and/or a number N_DMRSperssb of DMRS ports on the PUSCH time-frequency resource units corresponding to the one downlink beam, and the index information P_id, determine index information TF_id and DMRS port information DMRS_id of the PUSCH time-frequency resource unit corresponding to the index information P_id within a second predetermined time period.

8. A resource determination method of an electronic device, comprising:
obtaining resource configuration information of an uplink signal;
based on the resource configuration information, obtaining first mapping information between a downlink beam and a random access channel (RACH) resource, and second mapping information between the downlink beam and physical uplink shared channel (PUSCH) resource;
according to the first mapping information and the second mapping information, obtaining RACH resource mapped with the downlink beam and PUSCH resource mapped with the downlink beam, and determining third mapping information between the RACH resource and the PUSCH resource; and
according to the third mapping information and the determined RACH resource, determining an available PUSCH resource.

9. The resource determination method of claim 8, wherein the obtaining the resource configuration information of the uplink signal comprises obtaining the resource configuration information from at least one of:
a random access feedback of a random access process, downlink control information of scheduled uplink transmission, a radio resource control (RRC) configuration message, pre-configured parameter information, and a system message sent by a network side or other higher level control signaling.

10. The resource determination method of claim 8, wherein the resource configuration information comprises at least one of: four-step random access configuration information, two-step random access configuration information, downlink beam configuration information, and PUSCH resource configuration information.

11. The resource determination method of claim 8, wherein the obtaining the second mapping information between the downlink beam and the PUSCH resource comprises at least one of:
determining a mapping relationship between the downlink beam and a PUSCH time-frequency resource;
determining a mapping relationship between the downlink beam and a demodulation reference signal (DMRS) port;
determining a mapping cycle from the downlink beam to the PUSCH resource;
determining a mapping period from the downlink beam to the PUSCH resource; or
determining a mapping pattern period from the downlink beam to the PUSCH resource.

12. The resource determination method of claim 11, wherein the determining the mapping relationship between the downlink beam and the PUSCH time-frequency resource comprises:
mapping indexes of all downlink beams configured within one downlink beam period to PUSCH time-frequency resource units in the following at least one manner:
in an ascending order of indexes of available DMRS ports on one PUSCH time-frequency resource unit;
in an ascending order of indexes of PUSCH time-frequency resource units multiplexed in the frequency domain; or
in an ascending order of indexes of PUSCH time-frequency resource units multiplexed in the time domain.

13. The resource determination method of claim 11, wherein the determining the mapping relationship between the downlink beam and the DMRS port comprises:
when a number of downlink beams mapped on one PUSCH time-frequency resource unit is N>1, dividing N_DMRS DMRS ports on the one PUSCH time-frequency resource unit into N_DMRS/N groups, so that each of the downlink beams corresponds to one group of N_DMRS/N groups; and
when the number of the downlink beams mapped on the one PUSCH time-frequency resource unit is N≤1, mapping all DMRS ports on the one PUSCH time-frequency resource unit to this downlink beam.

14. The resource determination method of claim 8, wherein the determining the third mapping information between the RACH resource and the PUSCH resource comprises:
according to a determined transmission opportunity (RO) and a preamble on the RO, determining index information P_id of the preamble within a first predetermined time period; and
according to a number N_PUSCHperssb of PUSCH time-frequency resource units corresponding to one downlink beam and/or a number N_DMRSperssb of DMRS ports on the PUSCH time-frequency resource units corresponding to the one downlink beam, and the index information P_id, determining index information TF_id and DMRS port information DMRS_id of the PUSCH time-frequency resource unit corresponding to the index information P_id within a second predetermined time period.

15. A computer readable storage medium storing instructions that, when executed by a processor, cause the processor to:
obtain resource configuration information of an uplink signal;
based on the resource configuration information, obtain first mapping information between a downlink beam and a random access channel (RACH) resource, and second mapping information between a downlink beam and physical uplink shared channel (PUSCH) resource;
according to the first mapping information and the second mapping information, obtain RACH resource mapped with the determined downlink beam and PUSCH resource mapped with the determined downlink beam, and determine third mapping information between the RACH resource and the PUSCH resource; and
according to the third mapping information and the determined RACH resource, determine available PUSCH resource.
